(19) United States
(12) Patent Application Publication
(10) Pub. No.: US 2007/0234575 A1
(43) Pub. Date: Oct. 11, 2007

(54) Demolition tool

(76) Inventor: Willie Petty, St. Louis, MO (US)

Correspondence Address: HUSCH & EPPENBERGER, LLC, 190 CARONDELET PLAZA, SUITE 600, ST. LOUIS, MO, 63105-3441, US

(21) Appl. No.: 11/398,000

(22) Filed: Apr. 5, 2006

(51) Int. Cl. B26B 3/00

(52) U.S. Cl. 30/299

(57) ABSTRACT

A telescoping demolition tool used primarily to aid contractors and other construction workers in removing ceiling materials while performing demolition work. The telescoping feature allows the user to reach varying ceiling heights without the use of a ladder or scaffolding. The stake is generally used to punch holes in the ceiling so that the user may insert the blade within the ceiling cavity and pull the ceiling material from its securings. The retractable feature of the stake allows for precise demolition work as the user, after punching the required number of holes in the ceiling, may retract the stake to a position within or along side the pole such that the user will not have to worry about damaging the underside of the flooring located above the ceiling while using the bade to pull down the ceiling materials. In addition, the stake may contain a cutting element which allows the user to cut around certain impediments located within the ceiling material.

### BACKGROUND OF THE INVENTION

1. Field of the Invention

This invention relates generally to tools used for demolition work. The demolition tool disclosed herein is designed to help users remove ceiling materials (i.e. drywall panels, plaster ceilings, or suspended ceilings) and/or perform other general demolition work in a safe, precise, and more efficient manner. The present invention also allows such work to be accomplished with less threat of damage to other areas of the accompanying walls, ceiling, and flooring.

2. Related Art

In the construction business in general and more specifically in the remodeling business, there is a need for a tool that allows the user to safely and precisely remove ceiling material while performing demolition work. Removal of the current ceiling material is often a necessary part of the project. In the current practice, a hammer or pry bar is used to separate the ceiling material from its securings. As such, contractors must work from a ladder or scaffolding since standard pry bars and hammers are simply not long enough to reach ceiling level if a contractor is standing on the floor. This can be somewhat dangerous since the worker will often be positioned just below the section that is being removed. In addition, workers often attempt to extend their reach to areas outside the normal operation of the ladder or scaffolding thus giving them a greater opportunity to lose their balance, fall off the ladder or scaffolding, and sustain injury.

Because the contractor's reach is limited while standing on the ladder or scaffolding, the contractor must constantly climb up and down the ladder or scaffolding to reposition the equipment within the room so that he or she may complete the removal of the entire ceiling. This constant travel up and down the ladder or scaffolding wastes valuable time and creates a potentially unsafe working environment for the contractor. In addition, pieces of ceiling material already removed and laying on the floor prevents quick repositioning of the scaffolding as these ceiling pieces must be cleaned up before the scaffolding may be rolled to another location within the room.

Inventions in the prior art have attempted to address similar problems. However, many of these tools were developed with the primary focus of assisting fire fighters in removing walls and ceilings while fighting fires. An example is disclosed in U.S. Pat. No. 3,921,288 to Clemens, Jr. Because these tools were developed for use in different occupations, they are not tailored to meet the needs of a general construction worker and lack many of the features of the present invention. In addition, because of the way these inventions generally function, there is often a danger that sounding walls, ceiling, and flooring will receive unintended damage while the tool is being used. For example, the tool disclosed in Clemens Jr. has a fixed puncturing end. This creates a great risk that this puncturing end will damage the flooring located above the ceiling as the tool is being used to pull down the ceiling material. While this is generally not a concern to a fire fighter, unintended damage caused during a demolition job could result in the contractor incurring additional and unexpected costs. In addition, because the puncturing end is fixed in position, it is often difficult for the user to maneuver the tool within the confined spaces of the ceiling cavity.

Finally, similar tools disclosed in the prior art are often fixed in length. As such, they are generally not long enough to reach higher ceilings. Because of the lack of an extending feature, operators of those tools generally need to stand on scaffolding or ladders to use the tool properly.

As such, there is a need in the art for a telescoping demolition tool that can be used by an operator without having to climb up and down ladders or scaffolding and can be used without the threat of damaging surrounding wall, ceiling, and floor material not intended to be a part of the demolition.

### SUMMARY OF THE INVENTION

It is in view of the above problems that the present invention was developed. The invention is a demolition tool having a telescoping pole and a retractable stake in combination with a blade.

The retracting feature of the stake allows the user to move the tool more easily within the ceiling cavity and reduces the chances of damaging other items located above the ceiling or behind the surrounding walls.

This invention allows a contractor to remain on the floor during the demolition work, in turn providing him or her with a much safer working environment. With this invention, a contractor can punch a hole into a ceiling, push the blade into the hole, and then pull in a downward fashion, thereby prying large sections of the ceiling from the framing members. Also, a worker's range of motion would not be restricted by a ladder or scaffolding. Therefore, the worker would no longer be in danger of over-reaching and falling off such ladder or scaffolding while trying to remove the ceiling material. In this manner, a contractor could save a substantial amount of time and effort, while avoiding one of the dangerous conditions associated with demolition work.

In addition, because the length of the tool can be adjusted, the user may stand on the floor in a position that is not directly beneath the area of ceiling being removed. This feature obviously allows the user to operate the tool without the potential danger of having pieces of ceiling material fall on top of him or her.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 is a view of the demolition tool;

FIG. 2 is a first embodiment of the retractable stake in both extended and retracted positions;

FIG. 3 is a second embodiment of the retractable stake in both extended and retracted positions; and

FIG. 4 is a third embodiment of the retractable stake in both extended and retracted positions.

FIG. 5 is a fourth embodiment of the retractable stake showing the serrated edge.

### DETAILED DESCRIPTION OF THE PREFERRED EMBODIMENTS

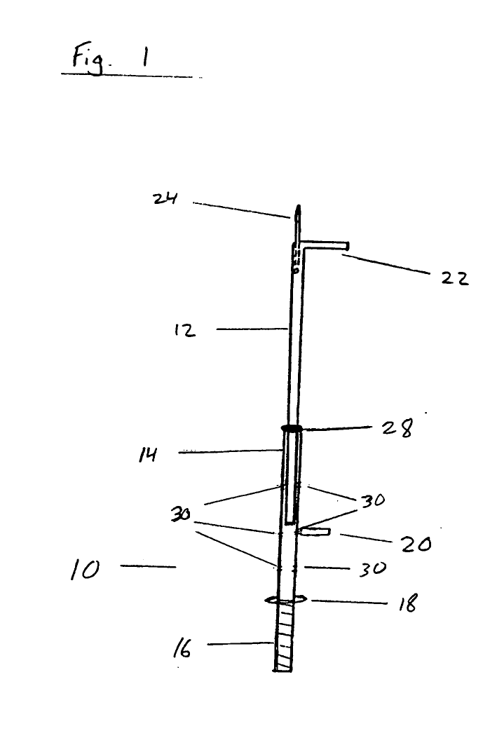

Referring to the accompanying drawings in which like reference numbers indicate like elements, FIGS. 1-5 are views of the present invention.

FIG. 1 shows the general aspects of the invention. As seen in this figure, the pole 10 has an inner rod 12 and an outer rod 14. The inner rod 12 is made of heavy wall steel tubing measuring approximately 1 inch in diameter. The outer rod 14 consists of the same heavy wall steel tubing but has a slightly larger diameter than the inner rod 12 such that the inner rod 12 may be slid into the outer rod 14 thus creating a telescoping feature for the tool. When fitted together, the inner rod 12 and outer rod 14 may be adjusted from 6 feet to 12 feet depending upon the height needed for the applicable project.

Once the desired height is achieved, a nut 28, communicating with both the inner rod 12 and the outer rod 14, is tightened so that the inner rod 12 will not retract back into the outer rod 14 while the operator is using the tool. Loosening of the nut 28 allows the inner rod to travel freely within the outer rod 14.

At the end of the inner rod 12 away from the outer rod 14 is a blade 22. This blade 22 may be a separate piece of piping welded to the end of the inner rod 12 at a certain predetermined angle. While a variety of angles are possible, the angle generally used is a 90-degree angle measured with respect to the inner rod 12. Instead of welding a separate piece of piping to the end of the inner rod 12, the blade 22 may also be formed by bending the inner rod 12 to the desired angle approximately 4 to 6 inches from its end. The blade 22 is the part of the tool used by the operator to pry the ceiling material from its securings.

At the same end of the inner rod 12 as the blade 22 there is a retractable stake 24. The stake 24 extends from the rod at approximately a 90-degree angle with the blade 22. When fully extended, the stake 24 rises to a height 4-6 inches above the blade 22. The stake 22 is generally used to punch holes in the ceiling material so that the operator may then insert the blade 22 and begin pulling the ceiling material away from its securings. Once the holes have been made in the ceiling, the stake 24 is generally retracted to a position within or along side the inner rod 12 so that additional, unintended damage does not occur to other areas of the ceiling, or the flooring located above the ceiling material, while the operator is using the blade 22 to pull the ceiling materials down. This retractable stake 24 feature adds a further advantage to the operator in that the stake 24, in its retracted position, does not get caught on objects located within the ceiling cavity while the blade 22 is being used. Therefore, the blade 22 may more easily maneuver within the ceiling cavity and is capable of being used in smaller spaces than would be possible with a fixed stake. Again, this allows the operator to perform more precise demolition work.

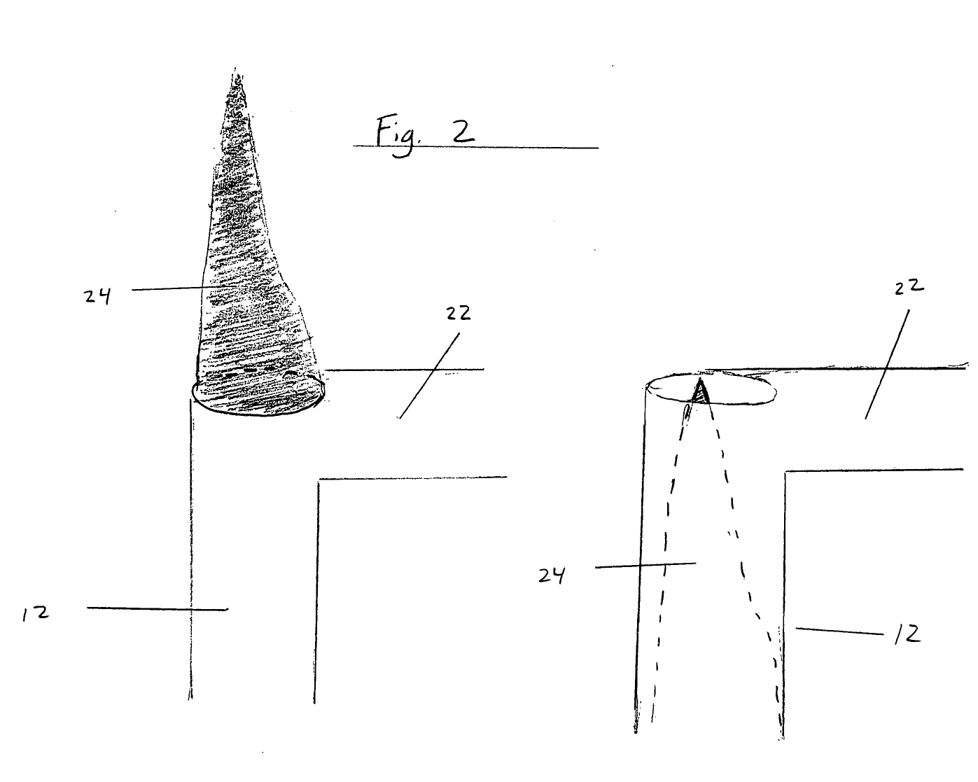

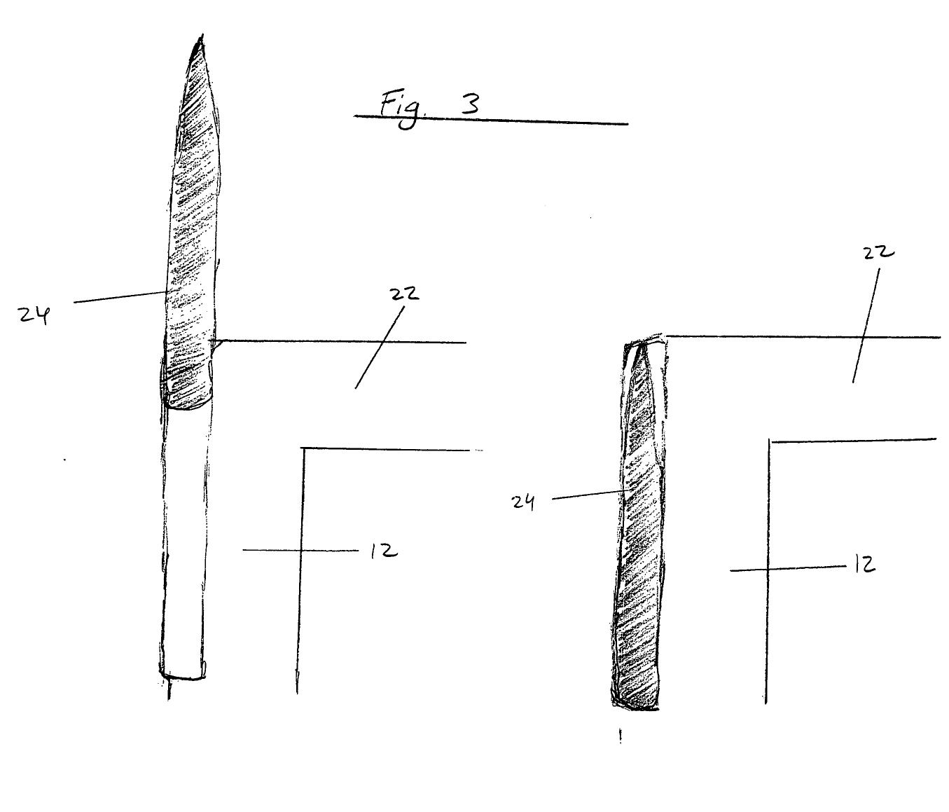

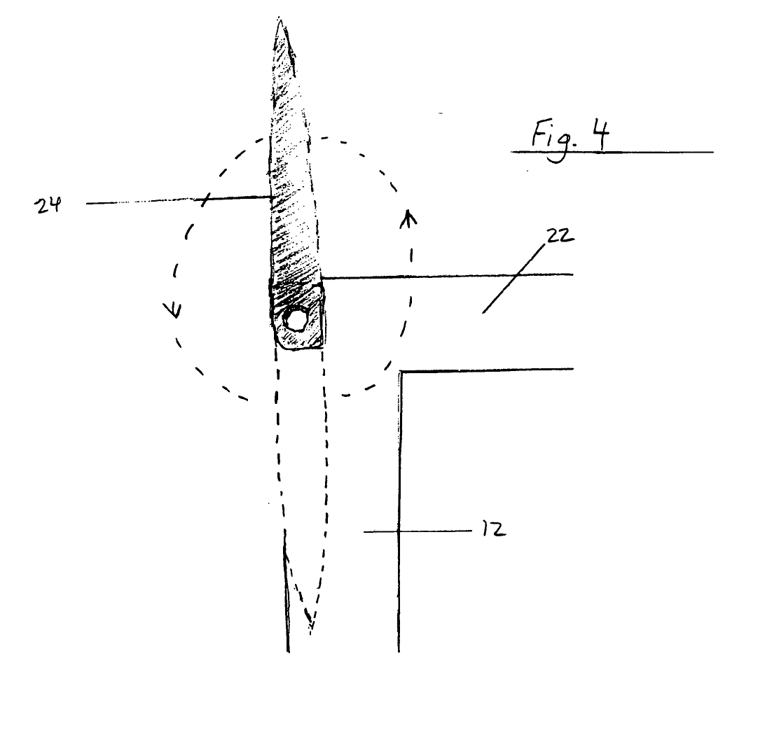

FIGS. 2-5 show various embodiments of the retractable stake 24. In the embodiment shown in FIG. 2, the stake 24 retracts from its extended position above the blade 22 to a position within the inner rod 12. In this embodiment, the operator merely slides the stake 24 from its extended position to the retracted position within the inner rod 12. In the embodiment shown in FIG. 3, instead of the stake 24 retracting to a position inside the inner rod 12, the stake 24 retracts to a position on the outside of the inner rod 12. In this embodiment, the operator again merely slides the stake 24 from its extended position to its retracted position. In both of these embodiments, the stake 24 retracts to a position such that the end of the stake 24 is flush with the end of the inner rod 12. Finally, in a third embodiment shown in FIG. 4, the stake 24 retracts to a position on the outside of the inner rod 12. Instead of sliding into its retracted position, the stake 24 is rotated in a clockwise or counterclockwise fashion around a point at which the stake 24 is attached to the inner rod 12. In this embodiment, the retracted position is approximately 180 degrees from the extended position.

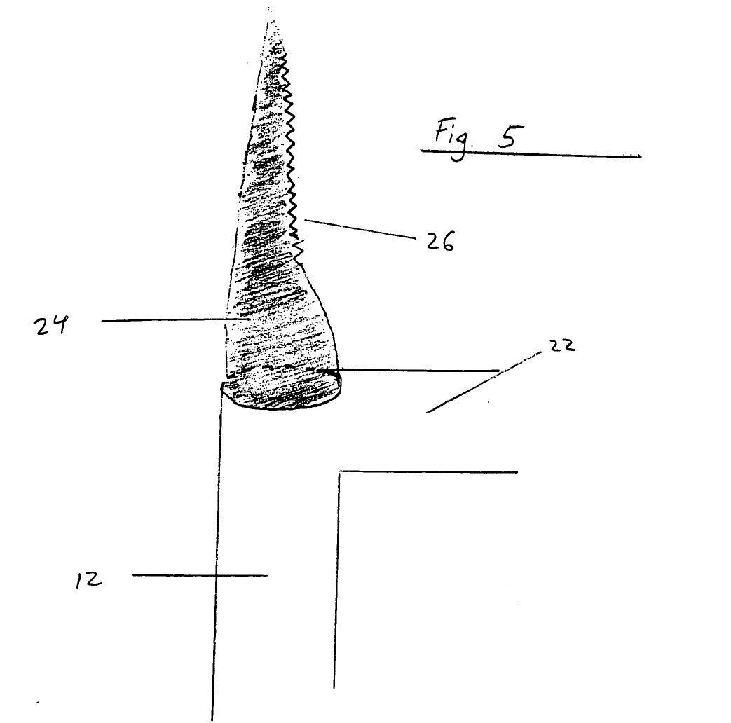

FIG. 5 shows another embodiment of the retractable stake. In this embodiment, one side of the stake has a serrated edge 26 such that the stake may be used in a saw-like fashion to cut around certain impediments in the ceiling, such as canned lights and other objects, the user may not wish to remove in the demolition. Such feature allows the user to perform more precise demolition work.

At the end of the outer rod 14 away from the inner rod 12 there is a grip 16. This grip 16 is generally made of rubber but may be made of any material that gives the operator a better ability to hold the end of the tool. In one embodiment, a circular plate 18 is located above the grip 16 that helps the user obtain additional leverage to raise the tool and punch holes into the ceiling with the stake 24. The user may place his or her hand beneath the circular plate 18 giving him or her more surface area to apply force while thrusting the stake 24 into the ceiling material. In addition, this circular plate 18 helps protect the user's hand from falling debris while the tool is being used. On various parts of the outer rod 14, there are attachment points 30 at which a handle 20 may be attached. The handle 20 is used to help the user create enough downward force to pull the ceiling material away from its securings. The attachment points 30 are located on both sides of the outer rod such that the handle 20 may be adjusted to accommodate both right and left handed users. In addition, the handle 20 may be adjusted to several heights along the outer rod 14.

In view of the foregoing, it will be seen that the several advantages of the invention are achieved and attained.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. For example, the inner and outer rods may be made of materials other than heavy wall steel tubing. Any metal or other material may be used that is strong enough to withstand the prying and pulling required in using the tool and is light enough to prevent the users from experiencing undue muscle strain. Thus, the breadth and scope of the present invention should not be limited by any of the above-described exemplary embodiments, but should be defined only in accordance with the following claims appended hereto and their equivalents.

What is claimed is:

1. A demolition tool comprising:
a pole having a first end and a second end,
a blade, said blade extending from said second end of said pole;
a stake, said stake located at said second end of said pole, wherein said stake translates between a first position within said pole and a second position extending from said second end of said pole.

2. The demolition tool of claim 1, wherein at least one side of said stake has a serrated edge.

3. The demolition tool of claim 1, further comprising:
a grip located at said first end of said pole;

4. The demolition tool of claim 1, wherein said pole extends from a first position of shorter length to a second position of greater length.

5. The demolition tool of claim 1, wherein said pole comprises an inner rod and an outer rod.

6. The demolition tool of claim 5, wherein said inner rod is located within said outer rod such that said inner rod may slide within said outer rod.

7. The demolition tool of claim 5, wherein said stake and said blade are located at a first end of said inner rod.

8. The demolition tool of claim 5, wherein said stake translates from a first position within said inner rod to a second position extending from said first end of said inner rod.

9. The demolition tool of claim 5, wherein said stake translates from a first position on the outside of said inner rod to a second position extending from said first end of said inner rod.

10. The demolition tool of claim 5, wherein said stake rotates from a first position on the outside of said inner rod to a second position extending from said first end of said inner rod.

11. The demolition tool of claim 5, further comprising:
a nut in communication with said inner rod and said outer rod, whereby rotation of said nut in a first direction restricts movement of said inner rod within said outer rod and rotation of said nut in a second direction allows such movement.

12. The demolition tool of claim 1, further comprising:
a disk mounted on said pole.

13. The demolition tool of claim 12, wherein said disk is located on said pole between said grip and said blade.

14. The demolition tool of claim 12, wherein said disk is substantially circular.

15. The demolition tool of claim 1, further comprising:
a handle attached to said pole.

16. The demolition tool of claim 15, wherein said pole contains a plurality of attachment points wherein said handle may be attached to any one of said attachment points.

17. The demolition tool of claim 5, wherein said outer rod contains a plurality of attachment points wherein a handle may be attached to any one of said attachment points.

18. A demolition tool comprising:
a puncturing means;
a prying means; and
a connecting means;
wherein said connecting means connects said puncturing means and said prying means, and said puncturing means retracts from an extended position extending above said connecting means to a retracted position within said connecting means.

19. The demolition tool of claim 18, wherein said puncturing means is a stake, said prying means is a blade, and said connecting means is a pole.

20. The demolition tool of claim 18, further comprising:
a cutting means.

21. The demolition tool of claim 20, wherein said cutting means is located on said puncturing means.

22. The demolition tool of claim 21, wherein said cutting means is a serrated edge.
